(19) United States
(12) Patent Application Publication
(10) Pub. No.: US 2012/0182928 A1
(43) Pub. Date: Jul. 19, 2012

(54) WIRELESS INTERNET CONNECTION REPEATER WITHOUT SIGNAL INTERFERENCE

(75) Inventors: Kwang-kyu KOH, Seoul (KR); Nam-kyu CHO, Hwaseong-si (KR)

(73) Assignee: INTERBRO CO., LTD., Seoul (KR)

(21) Appl. No.: 13/429,956

(22) Filed: Mar. 26, 2012

Related U.S. Application Data
(63) Continuation of application No. 12/423,959, filed on Apr. 15, 2009, now abandoned.

(30) Foreign Application Priority Data
Sep. 19, 2008 (KR) 10-2008-0092274

(51) Int. Cl. H04W 88/04

(52) U.S. Cl. 370/315

(57) ABSTRACT

Disclosed is a wireless Internet connection repeater, and more particularly, a wireless Internet connection repeater without signal interference between a local area wireless communication module (WiFi module) and a broadband wireless communication module (WiMAX module). The wireless Internet connection repeater includes a broadband wireless communication module which includes a master packet control mediator for outputting status information of data transmission/receipt between the broadband wireless communication module and a base station in a broadband wireless network, and a local area wireless communication module which includes a slave packet control mediator for transmitting and receiving data to/from client terminals in synchronization with the status information from the master packet control mediator.

### CROSS REFERENCE TO RELATED APPLICATIONS

The present application is a continuation of U.S. patent application Ser. No. 12/423,959, filed on Apr. 15, 2009, and claims the benefit under 35 U.S.C. §119(a) of Korean Patent Application No. 10-2008-0092274, filed on Sep. 19, 2008, the entire disclosures of which are incorporated herein by reference.

### BACKGROUND

1. Field

The following description relates to a wireless Internet connection repeater, and more particularly, to a wireless Internet connection repeater without signal interference between a local area wireless network module (wireless fidelity (WiFi) module) and a broadband wireless network module (world interoperability for microwave access (WiMAX) module).

2. Description of the Related Art

With the development of communication technologies and mobile terminal related technologies, there have been introduced various communication methods. WiFi is a local area communication technology using microwave transmission in a wireless local area network (WLAN). WiFi allows wireless data transmission/receipt and is rather cost-effective, but has speed and range limitations.

To overcome such limitations, wireless broadband Internet connection services including Wibro (Wireless Broadband) and WiMAX (world interoperability for microwave access) have been introduced. WiMAX service is based on the IEEE802.16d/e standards, and allows high-speed Internet access even in motion at a moderate speed (up to 120 km/h) by use of a frequency band of 2.3 GHz, 2.5 GHz, 3.5 GHz, or 5 GHz. For information, a terminal having a broadband wireless communication module such as WiMAX module communicates with a base station wirelessly, and is connected to the Internet network either wired or wirelessly.

It may be considered that WiMAX service has higher availability than wireless LAN service in that the WiMAX scheme has advanced mobility in a high-speed environment and has no distance limitation. However, the WiMAX service cannot be used as intended by terminals that support only wireless LAN service. For this reason, wireless Internet connection devices or repeaters have been developed to allow wireless LAN terminals to access the WiMAX service network.

However, in use of usual wireless Internet connection devices or repeaters, signal interference may occur between the local area wireless communication module (WiFi module) and the broadband wireless communication module (WiMAX module). In other words, if there are different devices at the same location, which support different wireless communication schemes, and signal bands used by the devices are similar to each other, signal interference is likely to occur. For example, if a broadband wireless communication module transmits signals using the 2.3 GHz band while a local area wireless communication module is transmitting signals using the 2.4 GHz band, signal interference is not problematic since transmission powers of the neighboring modules are not greater than 20 dB. However, if one module receives signals and the other module transmits signals, there may take place the signal interference between the modules. Such problem can be resolved by making operation modes of both modules the same.

### SUMMARY

There is disclosed a seamless wireless Internet connection repeater which does not cause signal interference between a local area wireless communication module and a broadband wireless communication module.

According to another aspect, there is disclosed a wireless Internet connection repeater comprising: a broadband wireless communication module which includes a master packet control mediator for outputting status information of data transmission/receipt between the broadband wireless communication module and a base station in a broadband wireless network, and a local area wireless communication module which includes a slave packet control mediator for transmitting and receiving data to/from client terminals in synchronization with the status information from the master packet control mediator.

As such, the operation modes of the broadband wireless communication module and the local area wireless communication module are synchronized with each other, and thus signal interference between both communication modules is possible to be avoided.

Furthermore, during a section of data receipt from a base station, the master packet control mediator of the wireless Internet communication repeater may transmit a notification of data receipt mode to the slave packet control mediator, or transfer current status information to the slave packet control mediator in response to a status information request.

The status information may include a notification of end of downlink, a notification of completion of data transmission to a base station, and a notification of data receipt mode.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is an illustration showing peripherals of a mobile wireless Internet connection repeater according to an exemplary embodiment.

FIG. 2 is a block diagram of a wireless Internet connection repeater according to an exemplary embodiment.

FIG. 3 is a block diagram of a local area wireless communication module and a broadband wireless communication module in FIG. 2.

FIG. 4 is a flowchart of synchronization of operation modes of communication modules in FIG. 2 according to an exemplary embodiment.

FIG. 5 is a timing diagram of message transmission between the communication modules in FIG. 2.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein will be suggested to those of ordinary skill in the art. Also, descriptions of well-known functions and constructions are omitted to increase clarity and conciseness.

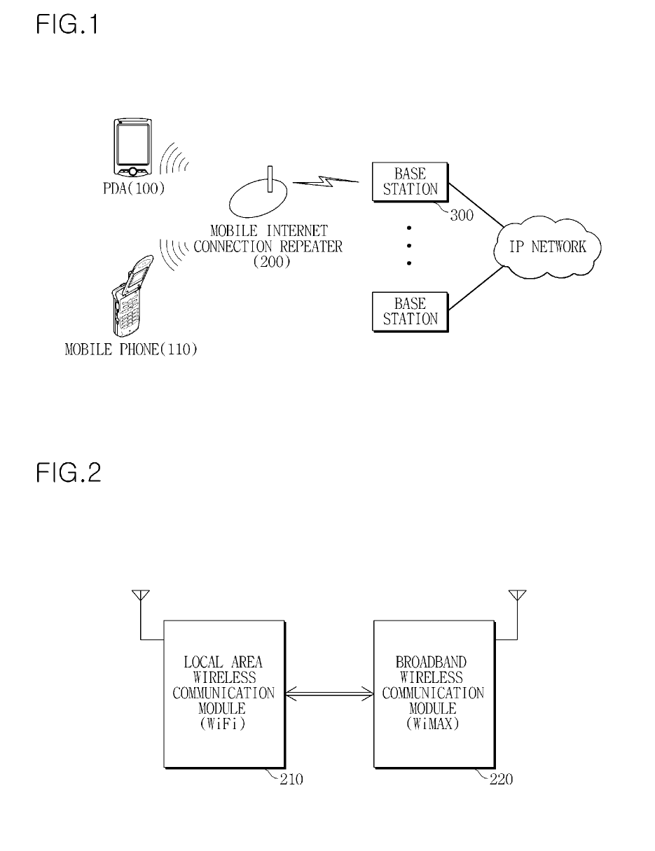

FIG. 1 is an illustration showing peripherals of a mobile wireless Internet connection repeater 200 according to an exemplary embodiment. Referring to FIG. 1, the mobile wireless Internet connection repeater 200 includes a local area wireless communication module 210 based on one of standards of IEEE802.11Aa, IEEE802.11b, and IEEE802.11g, to be connected to mobile terminals 100 and 110 and includes a wireless broadband communication module 220 based on IEEE802.16e technology to be connected to wireless broadband network. That is, the wireless Internet connection repeater 200 acts as a repeater which allows terminal accessible to a wireless LAN to connect to a wireless Internet through a wireless broadband network. Structures of the wireless Internet connection repeater 200 will be described with reference to FIGS. 2 to 4 later.

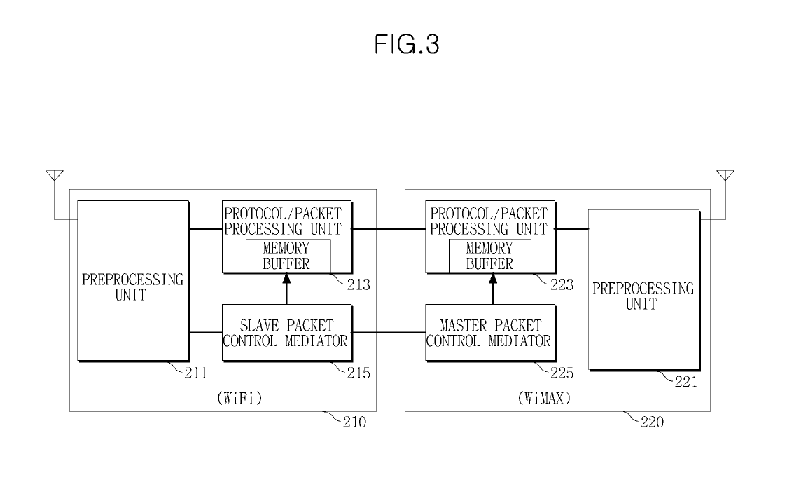

FIG. 2 is a block diagram of a wireless Internet connection repeater 200, and FIG. 3 is a block diagram of a local area wireless communication module (hereinafter, referred to as a WiFi (wireless fidelity) module) 210 and a wireless broadband communication module (hereinafter, referred to as a WiMAX (world interoperability for microwave access) module) 220 in FIG. 2.

Referring to FIGS. 1 and 2, the wireless Internet connection repeater 200 in accordance with an exemplary embodiment includes client terminals 100 and 110, each of which includes a wireless LAN module, the local area wireless communication module 210 for communication based on wireless protocol scheme, and the broadband wireless communication module 220 for communication with a base station 300 in a wireless broadband network.

The broadband wireless communication module 220 includes a master packet control mediator for outputting a status of data transmission and receipt with a base station 300, and a local area wireless communication module 210 includes a slave packet control mediator for control data transmission and receipt with the terminals 100 and 110 in synchronization with status information output from the master packet control mediator. Through the synchronization, operation modes of the broadband wireless communication module 220 and the local area wireless communication module 210 are made the same. In other words, the slave packet control mediator makes the transmission/receipt mode of the local area wireless communication module 210 the same as the mode of the broadband wireless communication module 220 according to status information transmitted from the master packet control mediator.

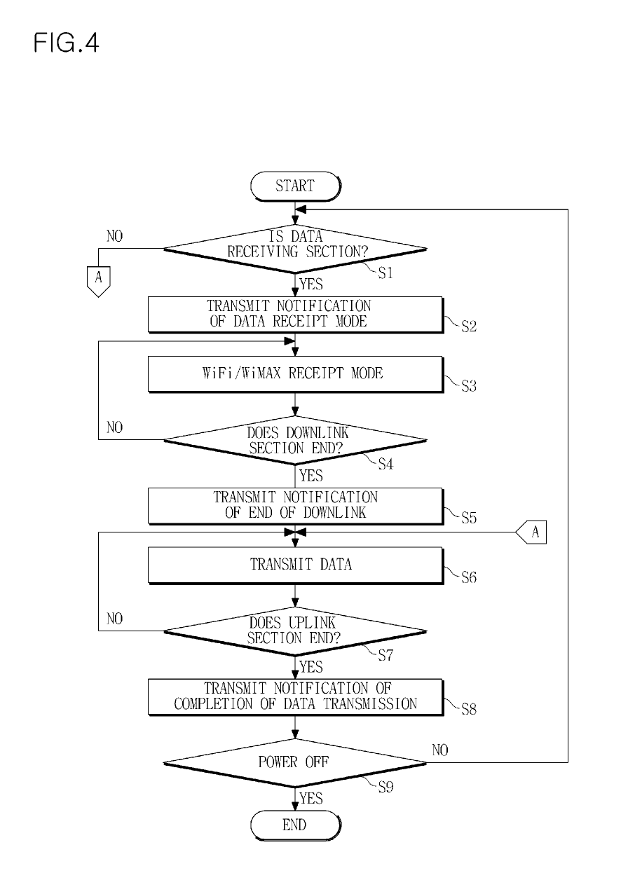

For reference, the master packet control mediator transmits status information to the slave packet control mediator. The status information may include at least a notification of completion of downlink, a notification of completion of data transmission to a base station, and a notification of data receipt. The notification flows between the master packet control mediator and the slave packet control mediator will be described in detail with reference to FIG. 4.

The repeater 200 may further include, besides the modules 210 and 220, a power supplying unit which performs down-conversion on alternating current common voltage to generate power to be provided and a battery rechargeable from the power supplying unit.

FIG. 3 is a block diagram of the local area wireless communication module 210 and the broadband wireless communication module 220 in FIG. 2. Referring to FIG. 3, the local area wireless communication module 210 and the broadband wireless communication module 220 includes preprocessing units 211 and 221, respectively. Each of the preprocessing unit 211 and 221 includes a filter, a transmission/receipt unit, and a modem. The filter divides radio frequency (RF) signals, which are transmitted to and received from each of client terminals 100 and 110 or base stations 300, into transmitted signals and received signals. The transmission/receipt unit transmits and/or receives the RF signals. The modem modulates and/or demodulates the signals from the transmission/receipt unit according to corresponding wireless communication standards.

The protocol/packet processing unit 213 of the local area wireless communication module 210 controls input/output of wireless packets according to a wireless MAC protocol such as IEEE802.11a/b/g, and processes the wireless LAN packets to be WiMAX packets. The protocol/packet processing unit 213 includes a buffer memory which is under control of a WiFi RF physical layer protocol (PHY) processing unit, WiFi MAC processing unit and a slave packet control mediator 215. The buffer memory temporarily stores received data having processed packets, and the slave packet control mediator 215 controls the buffer memory to output the received data to the broadband wireless communication module 220.

The slave packet control mediator 215 controls data transmission/receipt between the local area wireless communication module and the client terminals 100 and 110 in synchronization with status information transferred from the master packet control mediator 225 which will be described later. More specifically, when receiving a notification (Rx request) of data receipt mode, the slave packet control mediator 215 controls the protocol/packet processing unit 213 to temporality discontinue data communication with the client terminals 100 and 110. If receiving a notification (status) of downlink end from the master packet control mediator 225, the slave packet control mediator 215 recognizes that the receipt of data is finished and proceeds to transmit the data. Furthermore, when receiving a notification (clear to send: CTS) of completion of data transmission to a base station from the master packet control mediator, the slave packet control mediator 215 becomes available to receive the data.

As described above, the slave packet control mediator 215 controls the transmission and receipt of data of the local area wireless communication module 210 corresponding to status information massages transferred from the master packet control mediator 225.

Like the local area wireless communication module 210, the broadband wireless communication module 220 includes a preprocessing unit 221, a protocol/patch processing unit 223, and the master packet control mediator 225. The preprocessing unit 221 is for transmission and receipt of wireless signal with the base station 300. The protocol/packet processing unit 223 is for wireless Internet connection with the base station 300, and the master packet control mediator 225 transfers to the slave packet control mediator 215 information of status of data communication with the base station 300 in a wireless broadband network.

The protocol/packet processing unit 223 of the broadband wireless communication module 220 also includes a WiMAX RF PHY processing unit, a WiMAX MAC processing unit, an a buffer memory. The buffer memory temporarily stores data having its packets processed and received from the base station 300, and the master packet control mediator 225 controls the buffer memory to output the data to the local area wireless communication module 210. Then, the master packet control mediator 225 transmits the status message, the CTS message, and the Rx request message to the slave packet control mediator 215 according to a downlink section and an uplink section of WiMAX TDD frames which is transmitted to and received from the base station 300.

Each of the local area wireless communication module 210 and the broadband wireless communication module 220 may include a memory for buffering the transmitted and received packets.

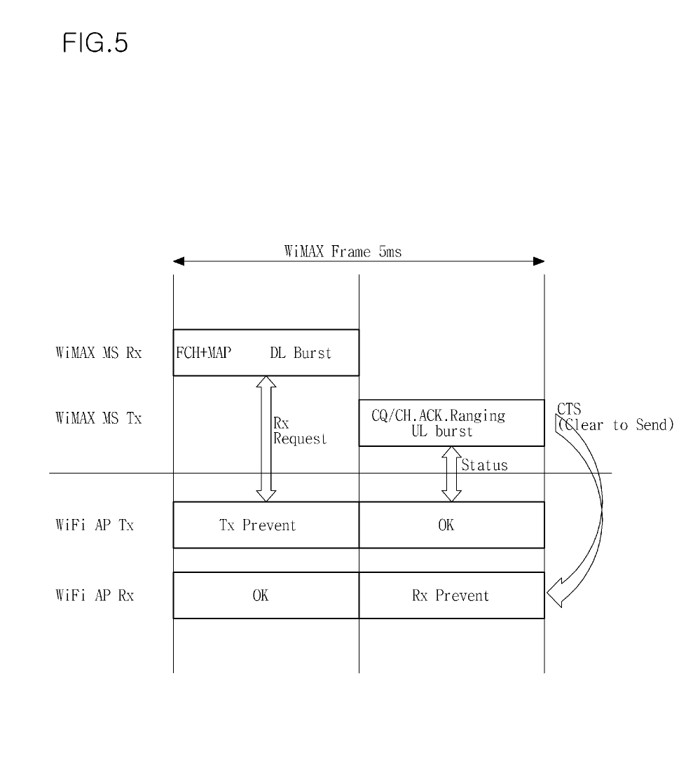

Hereinafter, operations of a wireless Internet connection repeater 200 including the above-described configurations in accordance with an exemplary embodiment will be described with reference to FIGS. 4 and 5.

FIG. 4 is a flowchart of synchronization of operation modes of communication modules according to an exemplary embodiment. FIG. 5 is a timing diagram of message transmission.

Referring to FIGS. 4 and 5, the master packet control mediator 225 of the broadband wireless communication module (WiMAX module in FIG. 5) 220 checks whether a current section of the WiMAX TDD frame is a data receipt section (FCH+MAP, DL₁₃ Busrt), that is, a downlink section of the frame by use of the protocol/packet processing unit 223 (operation S1). When it is determined that the current section is the data receipt section, the master packet control mediator 225 transmits an Rx request message to the slave packet control mediator 215 (operation S2).

The slave packet control mediator 215 that receives the Rx request message temporarily discontinues the data transmission by use of the protocol/packet processing unit 213 and controls the local area wireless communication module (WiFi module in FIG. 5) 210 to operate in a receipt mode. The operation modes of the local area wireless communication module 210 and the broadband wireless communication module 220 are synchronized to the receipt mode (operation S3), and the buffer memories of the protocol/packet processing units 213 and 223 of the respective communication modules 210 and 220 have received data sequentially stored therein.

If the downlink section (FCH+MAP, DL−Burst) of the WiMAX TDD frame ends as shown in FIG. 5 (operation S4), the master packet control mediator 225 transmits a status message that informs of end of downlink (operation S5). The slave packet control mediator 215 that receives the status message recognizes that the broadband wireless communication module 220 has its mode changed into the transmission mode to temporarily stop receiving (Rx) data and transmit (Tx) data. In the transmission (Tx) mode, data stored in the buffer memory of the broadband wireless communication module 220 is transmitted to a terminal through the local area wireless communication module 210.

Meanwhile, the master packet control mediator 225 that transmits the status message transmits the data to the base station 300 at the uplink section (CQ/CH, ACK, Ranging UL Burst) of the WiMAX TDD frame (operation S6). That is, the data stored in the buffer memory of the local area wireless communication module 210 is transmitted to the base station through the broadband wireless communication module 220. If the uplink section (CQ/CH, ACK, Ranging UL Burst) ends (operation S7), the master packet control mediator 225 transmits a CTS message that informs of completion of data transmission to the slave packet control mediator 215. Then, the slave packet control mediator 215 allows the local area wireless communication module 210 to continue to receive packet from the client terminals 100 and 110.

As described above, the master packet control mediator 225 transfers information of the current status of the broadband wireless communication module 220 to the local area wireless communication module 210 and the operation mode of the local area wireless communication module 210 is synchronized to the mode of the broadband wireless communication module 220. Accordingly, signal interference which may be caused by different operation modes can be effectively avoided.

According to the exemplary embodiment of the present invention, information of a current status of a broadband wireless communication module that performs data transmission/receipt with a base station in a wireless broadband network is transferred to a local area wireless communication module, and the local area wireless communication module in a repeater performs data transmission when a communication mode of the broadband wireless communication module is a transmission mode. Also, when the broadband wireless communication module is in a receipt mode, the local area wireless communication module allows only the data receipt, and thus signal interference which may occur due to different modes operating in each communication module can be avoided from the beginning

It will be apparent to those skilled in the art that various modifications and variations can be made in the present invention without departing from the spirit or scope of the invention. For example, while in the above exemplary embodiment, the master packet control mediator 225 transfers a notification of data receipt mode to the slave packet control mediator 215 unilaterally, the notification may be transferred in response to a request from the slave packet control mediator 215. Thus, it is intended that the present invention covers the modifications and variations of this invention provided they come within the scope of the appended claims and their equivalents.

What is claimed is:

1. A wireless Internet connection repeater comprising:
a broadband wireless communication module which includes a master packet control mediator for outputting status information of data transmission/receipt between the broadband wireless communication module and a base station in a broadband wireless network; and
a local area wireless communication module which includes a slave packet control mediator for transmitting and receiving data to/from client terminals in synchronization with the status information from the master packet control mediator.

2. The wireless Internet connection repeater of claim 1, wherein the slave packet control mediator makes an operation mode of the local area wireless communication module be the same as an operation mode of the broadband wireless communication module according to the status information.

3. The wireless Internet connection repeater of claim 1, wherein the master packet control mediator transmits at least a notification of end of downlink, a notification of completion of data transmission to a base station, and a notification of data receipt mode, as the status information.

4. The wireless Internet connection repeater of claim 1, wherein the master packet control mediator transmits the notification of data receipt mode to the slave packet control mediator during a section of a frame for receiving data from the base station.

5. The wireless Internet connection repeater of claim 4, where the master packet control mediator transmits at least a notification of end of downlink, a notification of completion of data transmission to a base station, and a notification of data receipt mode, as the status information.

6. The wireless Internet connection repeater of claim 1, wherein the slave packet control mediator issues a status information request to the master packet control mediator and controls data transmission/receipt to/from client terminals according to the response to the request.

7. The wireless Internet connection repeater of claim 1, wherein each of the broadband wireless communication module and the local area wireless communication module includes a protocol/packet processing unit including a buffer memory of which output is controlled by each of the master packet control mediator and the slave packet control mediator.

8. The wireless Internet connection repeater of claim 1, wherein each of the broadband wireless communication module and the local area wireless communication module is in accordance with at least one of a series of IEEE802.11 protocols and a series of IEEE802.16 protocols.
